(19) United States
(12) Patent Application Publication
(10) Pub. No.: US 2009/0079385 A1
(43) Pub. Date: Mar. 26, 2009

(54) Solar powered battery charger using switch capacitor voltage converters

(75) Inventors: Weidong Xiao, Port Moody (CA); Timothy James Roddick, Richmond (CA); Jason Leonard Scultety, Vancouver (CA)

Correspondence Address: Jason Scultety;MSR INNOVATIONS INC., 315-8988 Fraserton Court, Burnaby, BC, V5J 5H8, CA

(73) Assignee: MSR Innovations Inc., Burnaby (CA)

(21) Appl. No.: 12/283,962

(22) Filed: Sep. 17, 2008

Related U.S. Application Data
(60) Provisional application No. 60/974,242, filed on Sep. 21, 2007.

(51) Int. Cl. H02J 7/35

(52) U.S. Cl. 320/102

(57) ABSTRACT

The invention provides a charging device that uses switched capacitor voltage converters to charge a battery using solar power. The charger uses boosting topology to efficiently use solar module photovoltaic power. The boosting topology enables a lower voltage to be used resulting in reduced cutting and soldering of photovoltaic cells. The battery charger has overcharge protection and uses inductor-less circuitry.

This application claims priority from provisional patent application No. 60/974,242 filed on Sep. 21, 2007.

### BACKGROUND INFORMATION

There are numerous methods available for battery charging. Battery lifetime is directly related to how “deep” a battery is cycled (charge/discharge) each time. To extend the life of a battery, it is important to maintain a light battery cycle (i.e. keep deep cycling to a minimum). Certain batteries have low duty-cycle applications where the battery power is required infrequently. Self-discharge of the battery can result in losing some, or most, of the overall capacity. Applying trickle-charging can prolong the battery lifetime and keep the full battery capacity ready for immediate application.

Trickle charging, also called float charging or slow charging, is a battery charging method to maintain a full capacity battery during self-discharge. A solar powered battery charger, producing clean and free energy when exposed to sunlight, can provide a low charging current over a long period of time to maintain the trickle charge cycle. However, if the trickle-charging rate is higher than the level of self-discharge, the battery can also be overcharged and cause possible damage or reduced lifetime. Most of the solar battery chargers currently available on the market lack battery overcharge protection. Battery charging systems that utilize solar power are found in patents U.S. Pat. No. 4,453,119 and U.S. Pat. No. 7,030,597. The published applications include US2006/0267543 and US2006/0028166.

U.S. Pat. No. 4,453,119 and US2006/0267543 demonstrate a solar charged battery integrated with a voltage regulation circuit to prevent the overcharge of a car battery. The drawback of this design is that it requires the solar module output voltage to be higher than the battery voltage. This requires that many solar cells have to be connected in series to build the required voltage. For example, to charge a 12V car battery, a typical solar charger is comprised of 42 small solar cells connected in series (as traditional mono- and poly-crystalline solar cells produce a maximum of 0.7V each—and often considerably less). Ideally, all series-connected cells should be the same size and have the same characteristics. Otherwise, the overall performance can be degraded due to one degraded cell affecting the entire module output. From a solar cell manufacturing perspective, the cutting of solar cells should be minimized to avoid quality concerns and improve processing costs.

In U.S. Pat. No. 7,030,597, a regular step-up converter is adopted to charge the battery and minimize the number of series-connected cells. The drawback is the existence of an inductor and the related magnetic design issues. The switching inductor is usually bulky, costly, and difficult for integrated circuits. This also causes electromagnetic interference (EMI) problems, which. can lead to human health issues and disturbances to other devices. The primary difference between U.S. Pat. No. 7,030,597 and the invention is the topology used for voltage conversion.

### SUMMARY OF THE INVENTION

There is thus a need to provide a simple battery charger powered by solar that can reduce costs, eliminate EMI concerns and battery drainage, and effectively utilize solar module area. The battery charger of the invention provides a significant advantage by eliminating the inductor through the use of switched capacitor voltage converters. These are also called inductor-less DC/DC converter/regulators or charge pumps, which are capable of full integration. The circuit using switched capacitor voltage converters is simple and low cost when used with an integrated circuit. Integrated circuits (ICs) are readily available through many manufacturers, examples being Analog Device, Linear Technology, Texas Instruments, National Semiconductor, and Dallas Semiconductor. This invention also solves the complexity of providing a common ground, which limits the battery equal charge configurations. Moreover, since they require no external inductor, switched capacitor converters solve EMI issues related to inductor-based converters, as introduced in U.S. Pat. No. 7,030,597. Furthermore, the “boost” topology of this design results in a solar module output as low as 2V, which results in less cell cuts, fully utilized solar module area, and simple cell interconnection. Another advantage of this invention is that the battery overcharge problem can be avoided. The system does not drain power from the battery because the system power supply is controlled by the photovoltaic voltage. The system is automatically powered up when the photovoltaic power is available and is turned off when photovoltaic power is not available.

One drawback of using switched capacitor voltage converters is the limit of current output, typically less than 1 A. Unlike regular switching-mode converters, certain combinations limit the conversion ratio. Additionally, the resulting efficiency is usually lower than 90%. Despite these current disadvantages, switched capacitor voltage converters are still good alternatives for the application of a low-power solar battery charger.

### DRAWINGS

In drawings that illustrate embodiments of the invention,

FIG. 1 is a block diagram of the invention illustrating the regulation of photovoltaic voltage.

FIG. 2 is a block diagram of the invention illustrating the use of unregulated switched-capacitor voltage converters.

FIG. 3 illustrates an example of a solar battery charger using an LT1054 integrated circuit to configure a voltage doubler.

FIG. 4 shows a battery-charge topology using unregulated switched-capacitor voltage converters with bipolar-output.

FIG. 5 illustrates an example of a solar battery charger using an LT1054 integrated circuit to output bipolar voltage.

FIG. 6 demonstrates the topology of a voltage feedback loop that can regulate the converter output voltage.

FIG. 7 is a parallel form of charge operation with a central blocking device.

FIG. 8 is a parallel form of charge operation with an individual blocking device for each power interface.

FIG. 9 illustrates the schematics of a typical switched capacitor voltage converter used for a positive doubler for the application of a photovoltaic battery charger with a voltage feedback and control unit.

FIG. 10 illustrates the schematics of a typical switched capacitor voltage converter used for an inverter for the application of a photovoltaic battery charger

FIG. 11 illustrates the schematics of a typical switched capacitor voltage converter used for a positive tripler for the application of a photovoltaic battery charger with a voltage feedback and control unit.

### DETAILED DESCRIPTION OF THE INVENTION

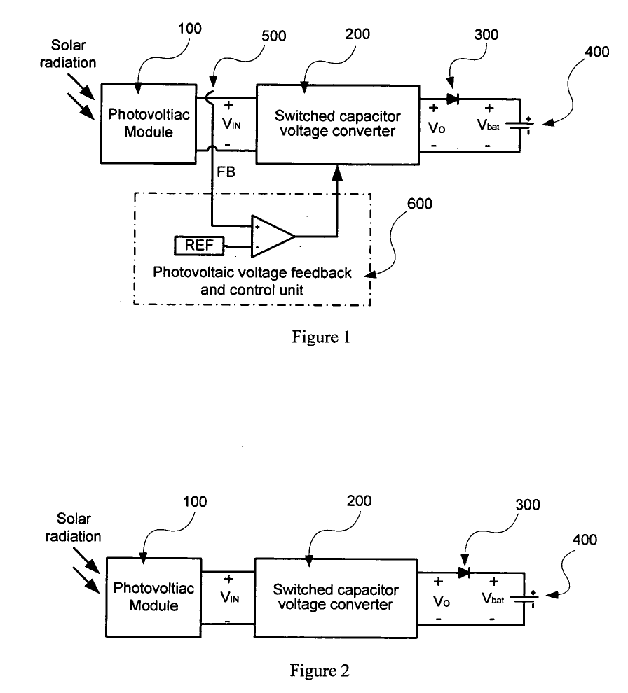

FIG. 1 shows an embodiment of the invention. The photovoltaic module (100) produces electric power when it is exposed to sunlight. To charge the battery (400), the switched capacitor voltage converter (200) serves as the power interface, which adopts the solar power and converts the voltage to a certain level, Vo. The power interface (200) can be comprised of a voltage doubler, and/or a voltage inverter, and/or a voltage tripler, or a combination of these topologies.

When solar power is available, the output voltage, Vo, should be higher than the battery voltage, Vbat. The capacity of photovoltaic power generation depends heavily on the presence of sunlight. At night, a current may flow back to the photovoltaic cells from devices that can supply electric power. This reverse current must be avoided because it can result in leakage loss, extensive damage, or even fire. The blocking device (300) should be used to prevent this reverse current flow.

In terms of maximum power point tracking, the regulation of photovoltaic voltage is required because there is an optimal operating voltage for each photovoltaic module. The voltage sensing unit (500) measures the photovoltaic voltage and feeds the signal to the voltage feedback and control unit (600). These two components will force the photovoltaic voltage to follow a predefined set-point, REF, which represents the maximum power point. This function will maximize the solar power output to charge the battery efficiently. The feedback and control unit compares the photovoltaic voltage and the reference REF, then, sends out the control signal to one of the switches. When the photovoltaic voltage is lower than the predefined reference, the switch will be turned off to increase the photovoltaic voltage. When the photovoltaic voltage is higher than the predefined reference, the photovoltaic voltage is not regulated, but, follow the change of the battery voltage, because the fixed conversion ratio of the switched capacitor voltage converter. Furthermore, this sensing and control functionality can serve as a voltage limiter to keep the photovoltaic voltage above a lower-limit, which deviates from the maximum power point.

FIG. 2 shows a simple embodiment of the invention, which ignores the sensing unit and the voltage feedback and control unit. Similarly, the photovoltaic module (100) produces electric power when it is exposed to sunlight. The switched capacitor voltage converter (200) serves as the power interface. The power interface (200) can be comprised of a voltage doubler, and/or a voltage inverter, and/or a voltage tripler, or a combination of these topologies. When solar power is available, the output voltage, Vo, should be higher than the battery voltage, Vbat. The blocking device (300) should be used to prevent this reverse current flow.

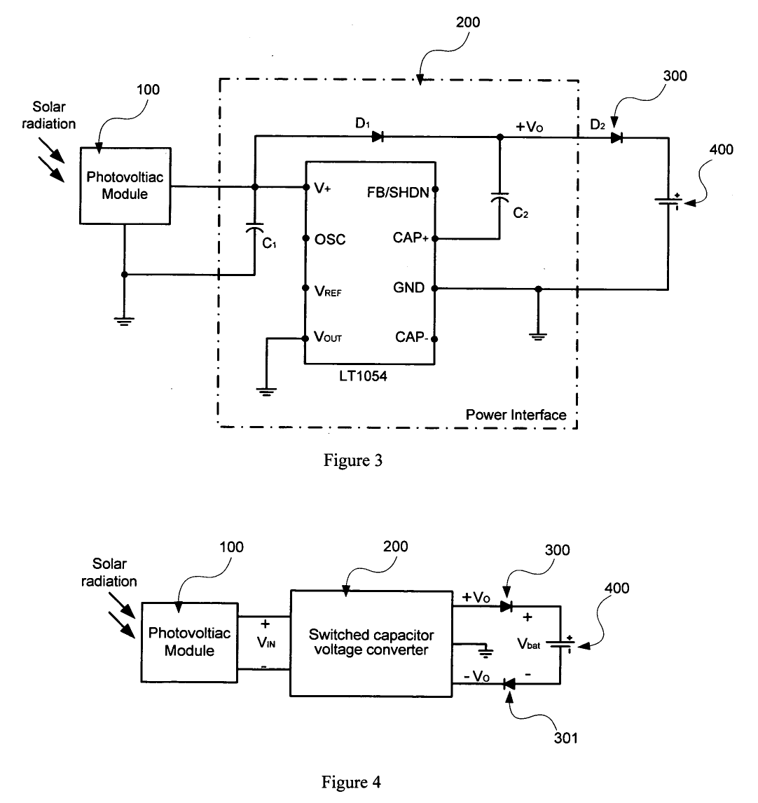

When an integrated circuit, such as LT1054, is used, the configuration of the power interface can be very simple, as shown in FIG. 3. The topology of the presented power interface is a positive voltage doubler, in which the output voltage is equal to twice the input voltage, regardless of voltage loss due to the switched capacitor topologies. As shown in FIG. 3, fewer components are required to bridge the photovoltaic module and the battery. D₂ is the block device to avoid any reverse current. The common block devices are diodes.

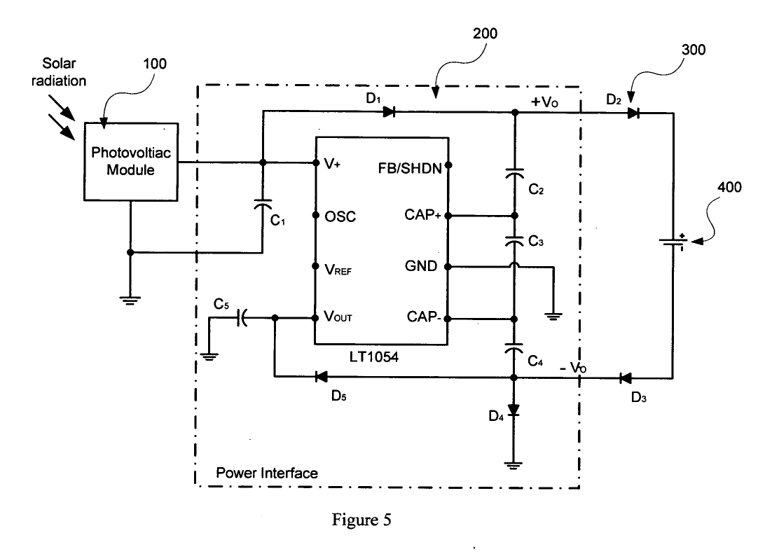

FIG. 4 illustrates a block diagram where the switched capacitor voltage converter (200) outputs a bipolar voltage, +Vo and −Vo. In this topology, the output voltage to the battery is doubled as 2Vo. The photovoltaic module (100) does not share a common ground with the battery (400). The blocking devices (300 and 301) prevent any reverse current. In some cases, the blocking device (301) can also be neglected because the device can keep the current going only in one direction. The major advantage of the bipolar output of switched capacitor voltage converters is the increase of the conversion ratio. Proper design can also minimize the switching component and cancel switching ripples on the output side. As shown in FIG. 5, the bipolar output can also be achieved by a single integrated chip, such as an LT1054 available through Linear Technology Inc.

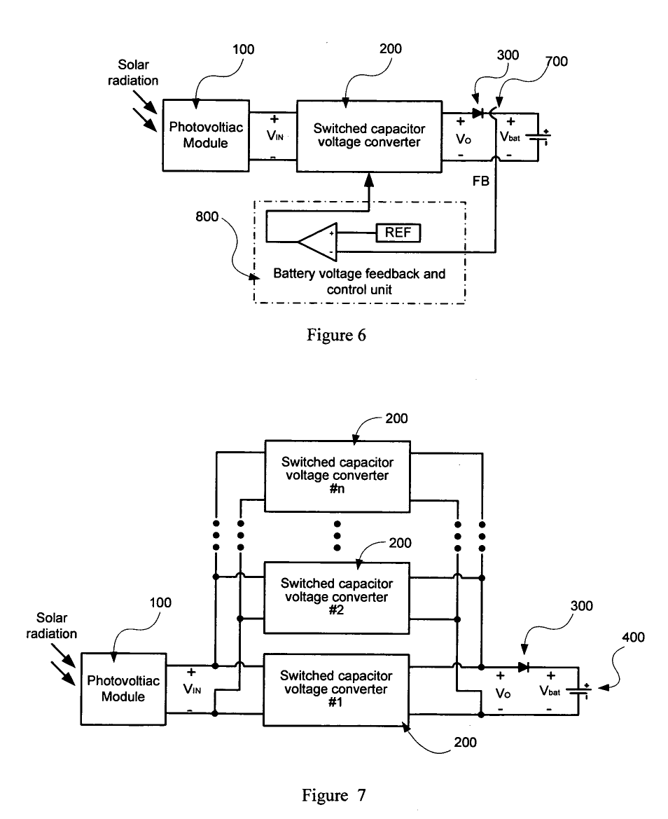

As shown in FIG. 6, the voltage feedback loop can regulate the converter output voltage. This function is useful when a high-performance charger is required to maintain the battery charge cycle. The battery voltage is sensed by the sensing unit (700). The battery voltage feedback and control unit (800) keeps the battery voltage lower than a certain threshold, REF, to avoid overcharge. The feedback and control unit compares the battery voltage and a reference, then, sends out control signal to one of the switches. When the battery voltage is higher than the predefined reference, the switch will be turned off to reduce the converter output voltage. When the battery voltage is lower than the predefined reference, the battery voltage is not regulated and takes the full charge energy for the solar module via the converter. In most cases, even while ignoring the output voltage regulation, the combination of the fixed conversion ratio of the switched capacitor voltage converters and the certain range of the photovoltaic voltage can generally prevent overcharging of the battery. Therefore, the sensing and voltage feedback and control units (700 and 800) can be neglected in a low-cost charger design.

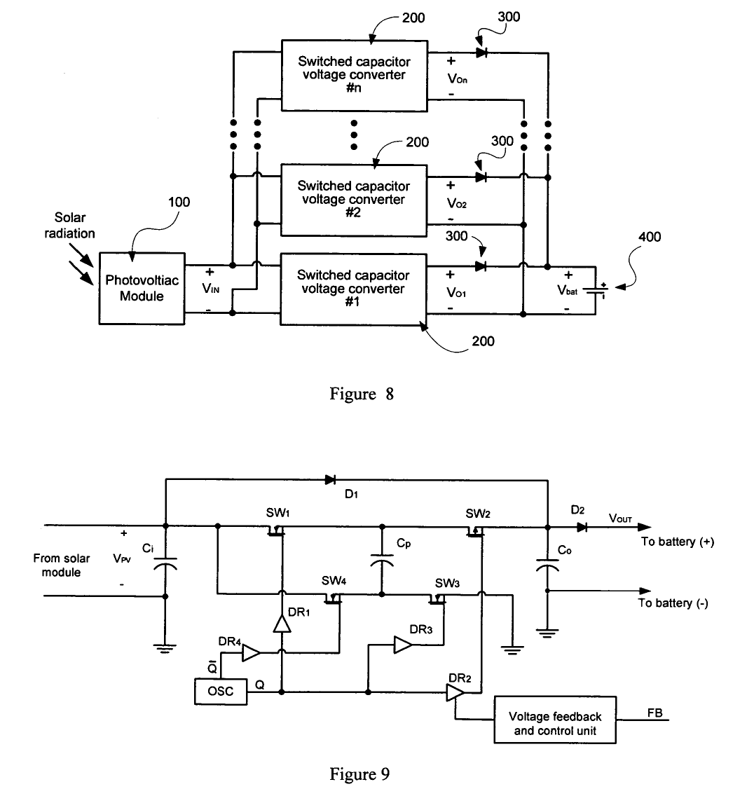

The power interfaces can operate in parallel to increase the charging capacity, as shown in FIG. 7 and FIG. 8. As shown in FIG. 7, the charge apparatus uses a central blocking device to prevent reverse current. FIG. 8 adopts individual diodes for each power interface, which is slightly different from the topology shown in FIG. 7. When metal-oxide-semiconductor field-effect transistors (MOSFETs) are used as switches for switched capacitor voltage converters, the positive temperature coefficient permits each converter module to share the output current equally and adaptively. The parallel topologies can adopt either unregulated switched capacitor converters (FIG. 2) or a regulated one (FIG. 1). This is extremely useful when the integrated circuits of switched capacitor voltage converters are limited by individual power capacity. To meet the power requirement, the quantity of converters can quickly be determined and connected in parallel.

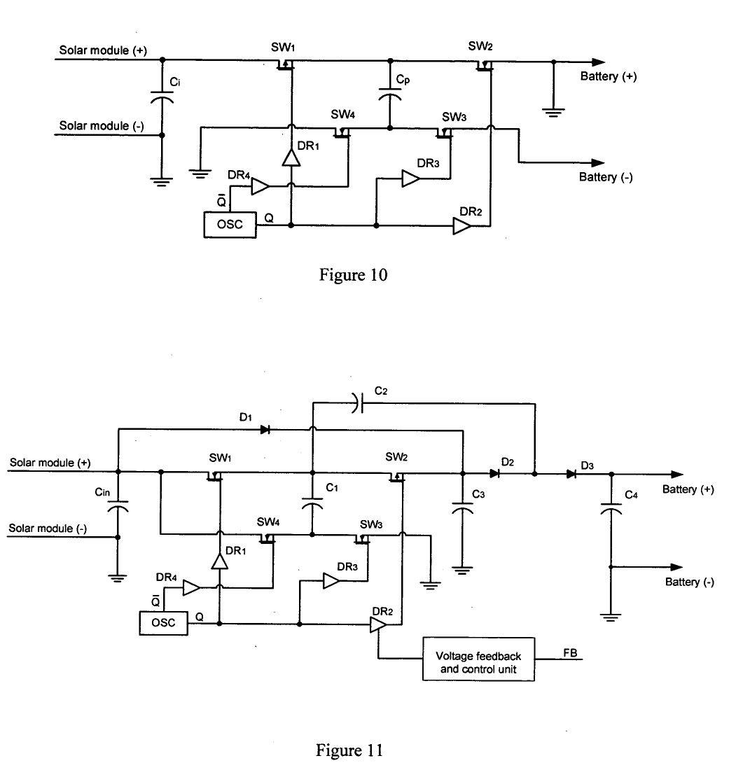

FIG. 9, FIG. 10, and FIG. 11 demonstrate the fundamental principle of switched-capacitor voltage converters configured as a voltage doubler, an inverter, and a tripler, respectively. As shown in FIG. 9, the unregulated output voltage of the positive voltage doubler is equal to twice the input voltage regardless of voltage loss due to the switched capacitor topologies. As shown in FIG. 10, the output voltage of the voltage inverter is the inverse of input voltage regardless of voltage loss due to the switched capacitor topologies. As shown in FIG. 11, the unregulated output voltage of the positive voltage tripler is equal to triple the input voltage regardless of voltage loss due to the switched capacitor topologies. Voltage drops must be considered in the converter design. Combinations of these topologies can give variable conversion ratios, of which an example is shown in FIG. 5. The switches used in these switched capacitor voltage converters can be metal-oxide-semiconductor field-effect transistors (MOSFET) or bipolar junction transistors (BJT). In FIG. 9 and FIG. 11, the control unit can be implemented to control either the photovoltaic voltage or the battery voltage, as shown in FIG. 1 and FIG. 6, respectively. The converters can be switched to an unregulated version by removing the control units shown in FIG. 9 and FIG. 11.

As such, an invention has been disclosed in terms of preferred embodiments thereof which fulfills each and every one of the objects of the present invention as set forth above and provides a new and improved solar powered battery charger.

Of course, various changes, modifications and alterations from the teachings of the present invention may be contemplated by those skilled in the art without departing from the intended spirit and scope thereof. It is intended that the present invention only be limited by the terms of the appended claims.

We claim:

1. A solar battery charger apparatus comprising:
a solar module;
an unregulated switched-capacitor voltage converter;
a blocking unit;
a battery.

2. A solar battery charger apparatus comprising:
a solar module;
a regulated switched-capacitor voltage converter;
a blocking unit;
a voltage sensing unit
a voltage feedback and control unit
a battery.

3. A solar battery charger apparatus comprising:
a solar module;
two or more switched-capacitor voltage converters connected in parallel;
a blocking unit;
a battery.

4. as per claims 1, 2,3, the switched capacitor voltage converter is powered by the solar module.

5. as per claims 1, 2,3, the switched capacitor voltage converter can be assembled by discrete components.

6. as per claims 1, 2,3, the switched capacitor voltage converter can be configured by integrated circuits.

7. as per claims 1, 2,3, the output of the switched capacitor voltage converter can be unipolar or bipolar. When the bipolar output is applied, the battery does not share the same ground as the photovoltaic module.

8. as per claims 1, 2,3, the switches used in the switched-capacitor voltage converters can be MOSFET or bipolar transistors.

9. as per claims 2,3, the voltage sensing unit can be either an independent circuit or an integration of the converter circuit.

10. as per claims 2,3, the voltage feedback and control unit can be either an independent circuit or an integration of the converter circuit.

11. as per claims 2,3, the voltage feedback and control unit can regulate the photovoltaic voltage to follow an optimal set-point, which represents the maximum power point.

12. as per claims 2,3, the battery voltage feedback and control unit can regulate the battery voltage to follow the battery charge cycle, which increases the charge efficiency and prevents battery overcharge.

13. as per claim 3, the power interface can operate in parallel to increase the charging capacity.

14. as per claims 2,3, the predefined reference can be set close to the optimal operating point that maximizes the photovoltaic power output.

15. as per claims 1, 2, 3, the topologies of switched capacitor voltage converters can be a positive doubler, a negative doubler, inverters, triplers, or any combination thereof.

16. as per claims 1, 2,3, the design of switched capacitor voltage converters can be customer-design circuits based on the principle of switched-capacitor voltage converters.
